(19) United States
(12) Patent Application Publication
(10) Pub. No.: US 2022/0174045 A1
(43) Pub. Date: Jun. 2, 2022

(54) REACTIVE SECURE COMMUNICATIONS

(71) Applicant: British Telecommunications Public Limited Company, London (GB)

(72) Inventor: Fadi El-Moussa, London (GB)

(73) Assignee: British Telecommunications Public Limited Company, London (GB)

(21) Appl. No.: 17/593,803

(22) PCT Filed: Mar. 18, 2020
(86) PCT No.: PCT/EP2020/057536

§ 371 Date: Sep. 24, 2021

(30) Foreign Application Priority Data
Mar. 27, 2019 (EP) 19165365.8

(51) Int. Cl. H04L 9/40; H04L 67/141

(52) U.S. Cl. CPC H04L 63/0272; H04L 63/205; H04L 63/061; H04L 67/141; H04L 63/0428

(57) ABSTRACT

A computer implemented method for providing secure communication channels between a host computer system and a plurality of communicating endpoint computer systems, the host executing a plurality of application instances, the method including initiating a secure communications tunnel between the host computer system and each communicating endpoint on an application basis such that each application instance has a separate communications tunnel, wherein each communications tunnel has associated security parameters including at least one cryptographic key for securely encrypting communications via the tunnel; and responsive to a detection of a security event in respect of an application instance at the host computer system, generating new security parameters for the tunnel of the application instance to provide a continuity of secure communication.

### PRIORITY CLAIM

The present application is a National Phase entry of PCT Application No. PCT/EP2020/057536, filed Mar. 18, 2020, which claims priority from EP Patent Application No. 19165365.8, filed Mar. 27, 2019, each of which is hereby fully incorporated herein by reference.

### TECHNICAL FIELD

The present disclosure relates to secure communication. In particular, it relates to secure communication reactive to security events.

### BACKGROUND

Secure communications channels in computer networks can be provided by virtual private networks (VPN) protocols such as IPSec (Internet Protocol Security), Point to Point Tunneling Protocol (PPTP) and Layer 2 Tunneling Protocol (L2TP). Such protocols provide a secure communication channel between communicating computer systems. However, such communication is typically on a whole-system basis—whether the system is physical or virtual.

U.S. Patent Publication No. 2015/0379278 A1 discloses techniques for encrypting data messages exchanged between guest virtual machines on different logical networks differently. However, still all communications between a guest virtual machine and endpoint will employ the same logical network. US 2015/0379278 A1 further discloses encrypting different types of data messages from the same guest virtual machine differently. However, having many encrypted data streams from a single guest virtual machine requires considerable management and coordination overhead, especially if security is compromised.

Thus, there is a challenge in providing secure encrypted communication for network endpoints that alleviates the aforementioned challenges.

### SUMMARY

According to a first aspect of the present disclosure, there is a provided a computer implemented method for providing secure communication channels between a host computer system and a plurality of communicating endpoint computer systems, the host executing a plurality of application instances, the method comprising: initiating a secure communications tunnel between the host computer system and each communicating endpoint on an application basis such that each application instance has a separate communications tunnel, wherein each communications tunnel has associated security parameters including at least one cryptographic key for securely encrypting communications via the tunnel; and responsive to a detection of a security event in respect of an application instance at the host computer system, generating new security parameters for the tunnel of the application instance to provide a continuity of secure communication.

In some embodiments, each communications tunnel is a virtual private network (VPN) connection.

In some embodiments, the security parameters include a security association negotiated between the host and an endpoint.

In some embodiments, the security association includes an exchange of cryptographic keys by an internet key exchange protocol.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for providing secure communication channels between a host computer system and a plurality of communicating endpoint computer systems according to embodiments of the present disclosure.

FIG. 3 is a flowchart of a method of providing secure communication channels between a host computer system and a plurality of communicating endpoint computer systems according to embodiments of the present disclosure.

### DETAILED DESCRIPTION

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

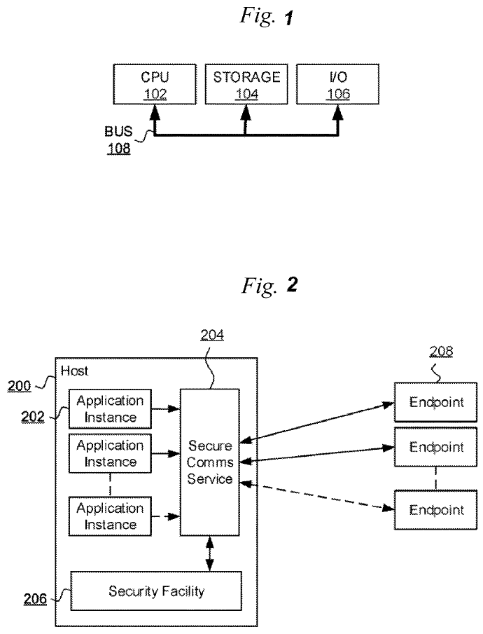

FIG. 2 is a component diagram of an arrangement for providing secure communication channels between a host computer system 200 and a plurality of communicating endpoint computer systems 208 according to embodiments of the present disclosure. The host 200 and endpoints 208 are physical or virtual computer systems suitable for communication therebetween via a communications network such as a wired, wireless or cellular network or a combination of any of these networks. Each endpoint 208 is, for example, a client computer system, a network host, a communications appliance such as a device as part of a network or telecommunications network, a media-streaming device or client, a pervasive and/or mobile device such as a portable computer, tablet, telephone or smartphone, or other devices as will be apparent to those skilled in the art.

The host 200 can include, for example, a server computer system, virtual machine or set of physical or virtual machines for executing a plurality of application instances 202. Each application instance 202 is an execution of a network software application by the host 200 operable to communicate with one or more endpoints 208 via the network. Notably, the application instances 202 can include multiple instances of the same application and/or instances of each of a set of different applications.

The host includes a security facility 206 as are known in the art such as, inter alia, one or more of: an intrusion detection service; a malware detection service; a virus detection service; an antivirus service; a firewall; or other security software and/or services as will be apparent to those skilled in the art. The host further includes a secure communications service 204 as a hardware, software, firmware or combination component such as a facility executing on the host 200. For example, the secure communications service 204 can be provided as a part of, adjunct to or interfaced with an operating system of the host 200. The secure communications service 204 is operable to initiate and provide a secure communications tunnel between the host computer system 200 and each communicating endpoint 208 on an application basis such that each application instance 202 has a separate communications tunnel. For example, a virtual private network (VPN) can be provided for each application instance such as an IPSec or L2TP tunnel. Each communications tunnel can be initiated by the service 204 in response to a request, by an endpoint 208, to communicate with an application instance 202 at the host. As part of initiating each communications tunnel the service 204 utilizes one or more parameters for the tunnel on which basis the tunnel security is determined. Such parameters can include, for example, one or more cryptographic keys for the tunnel. For example, a security association can be negotiated between the host 200 and an endpoint 208 in which an exchange of one or more cryptographic keys is performed as part of a key exchange protocol. In this way, each of the host 200 and endpoint 208 involved in a secure communication for an application instance 202 exchange and/or share cryptographic parameters required for the effective provision of a secure communications tunnel.

The secure communications service 204 is further operable responsive to detections, by the security facility 206, of security events. For example, a detection by the security facility 206 of an actual or potential security threat such as malware, virus or intrusion can trigger the secure communications service 204. The security event is detected in respect of an application instance 202 and responsive to the detection of a security event for an application instance 202 the secure communications service 204 is operable to generate new security parameters for the communications tunnel of the application instance. Such new security parameters are shared with an endpoint 208 communicating with the host 200 in respect of the application instance such as by recommencing a key exchange protocol for a virtual private network tunnel. In some embodiments, a communications tunnel is terminated and replaced with a new tunnel responsive to the security event. Thus, in this way, the secure communications tunnels provided on a per-application instance basis are reactive to security events such that continuity of secure communication can be provided following occurrence of a security event.

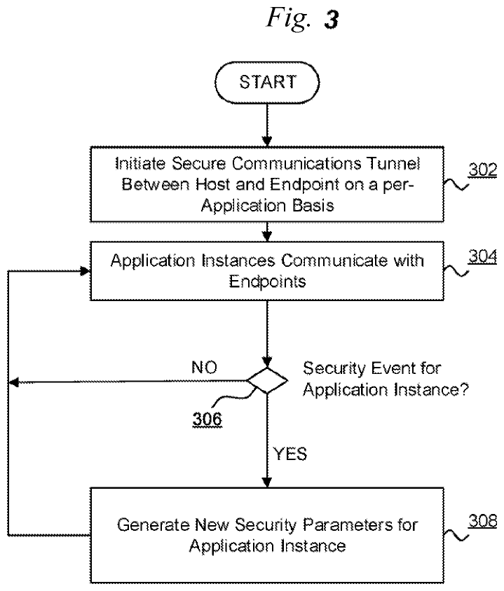

FIG. 3 is a flowchart of a method of providing secure communication channels between a host computer system 200 and a plurality of communicating endpoint computer systems 208 according to embodiments of the present disclosure. Initially, at 302, a secure communications tunnel is initiated between the host computer system 200 and each communicating endpoint 208 on an application basis such that each application instance has a separate communications tunnel. Each communications tunnel has associated security parameters including at least one cryptographic key for securely encrypting communications via the tunnel. At 304 endpoints 208 communicate with the host 200 in respect of application instances 202 via the secure communication tunnels. Subsequently, at 306, the method determines if a security event is detected in respect of an application instance 202 by the security facility 206. Where a security event is detected for an application instance 202, the method proceeds to 308 where new security parameters are generated for the communications tunnel of the application instance 202 to provide a continuity of secure communication.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for providing secure communication channels between a host computer system and a plurality of communicating endpoint computer systems, the host computer system executing a plurality of application instances, the method comprising:
initiating a secure communications tunnel between the host computer system and each communicating endpoint computer system on an application basis such that each application instance has a separate communications tunnel, wherein each communications tunnel has associated security parameters including at least one cryptographic key for securely encrypting communications via the communications tunnel; and
responsive to a detection of a security event in respect of an application instance at the host computer system, generating new security parameters for the communications tunnel of the application instance to provide a continuity of secure communication.

2. The method of claim 1 wherein each communications tunnel is a virtual private network (VPN) connection.

3. The method of claim 1 wherein the new security parameters include a security association negotiated between the host computer system and one of the plurality of communicating endpoint computer systems.

4. The method of claim 3, wherein the security association includes an exchange of cryptographic keys by an internet key exchange protocol.

5. A computer system comprising:
a processor and memory storing computer program code for providing secure communication channels between a host computer system and a plurality of communicating endpoint computer systems, the host computer system executing a plurality of application instances, by:
initiating a secure communications tunnel between the host computer system and each communicating endpoint computer system on an application basis such that each application instance has a separate communications tunnel, wherein each communications tunnel has associated security parameters including at least one cryptographic key for securely encrypting communications via the communications tunnel, and
responsive to a detection of a security event in respect of an application instance at the host computer system, generating new security parameters for the communications tunnel of the application instance to provide a continuity of secure communication.

6. A non-transitory computer-readable storage medium storing a computer program element comprising computer program code to, when loaded into a computer system and executed thereon, cause the computer system to perform the method as claimed in claim 1.
